(19) United States
(12) Patent Application Publication
(10) Pub. No.: US 2003/0144005 A1
(43) Pub. Date: Jul. 31, 2003

(54) Method and system for vehicle preference selection monitoring

(75) Inventor: Matt C. Videtich, Farmington Hills, MI (US)

Correspondence Address: ANTHONY LUKE SIMON, General Motors Corporation, Legal Staff, Mail code 482-C23-B21, 300 Renaissance Center, P.O. Box 300, Detroit, MI, 48265-3000, US

(73) Assignee: General Motors Corporation.

(21) Appl. No.: 10/052,504

(22) Filed: Jan. 30, 2002

(51) Int. Cl. H04Q 7/20

(52) U.S. Cl. 455/456

(57) ABSTRACT

The invention provides a method for vehicle preference selection monitoring by initiating communication between a mobile communication unit and a base station, requesting at least one vehicle preference setting from the mobile communication unit, receiving the vehicle preference setting request at the mobile communication unit, determining vehicle preference data for the mobile communication unit, transmitting to the base station the vehicle preference data from the mobile communication unit, and receiving the vehicle preference data at the base station.

### FIELD OF THE INVENTION

In general, the invention relates to data transmission over a wireless communication system. More specifically, the invention relates to a method and system for communicating a mobile vehicle preference selections and associated information.

### BACKGROUND OF THE INVENTION

Mobile communication units (MCU's), such as cellular phones, personal data assistants (PDA's), Global Positioning System (GPS) devices, and on-board Vehicle Communication Units (VCU's), used in conjunction with a Wide Area Network (WAN), such as a cellular telephone network or a satellite communication system, have made it possible for a person to send and receive voice communications, data transmissions, and FAX messages from virtually anywhere on earth. Such communication is initiated at the MCU when it is turned on, or by entering a phone number to be called, or in many cases, by pressing a preprogrammed button on the MCU or speaking a voice command causing the MCU to automatically complete the process of dialing the number to be called. A radio communication link is established between the MCU and a Wide Area Network (WAN), using a node of the WAN in the vicinity of the MCU.

In cellular telephone systems, a node is commonly referred to as a “cellular base station.” Once the radio communication link between the MCU and the cellular base station has been established, the base station then utilizes a combination of additional cellular stations, conventional telephone wire line networks, and possibly even satellite systems to connect the MCU to the number to be called.

Wireless communication services for MCU users, such as navigation and roadside assistance, have increased rapidly in recent years. Most of the services that have been offered are for a motor vehicle in operation, and include services that may require location and destination information. Such services are provided at a cost to the MCU users, and also at a cost to the MCU service provider. MCU service providers must make available a wireless communication service customer assistance center (or other such manually staffed service center) in order that an operator or customer assistant may complete the MCU requests. It would be beneficial to the MCU user and service provider to offer information and services advantageous to the MCU user, yet profitable to the MCU provider without MCU user subsidies. In addition, limited MCU equipped vehicle information is currently requested or used for the immediate advantage of the MCU user. Also, the current MCU equipped vehicle information is of little use to MCU providers or any other third party concern.

Thus, there is a significant need for a method and system for improving wireless communication services, vehicle information requests, and vehicle information use that overcome the above disadvantages and shortcomings, as well as other disadvantages.

### SUMMARY OF THE INVENTION

One aspect of the invention provides a method for vehicle preference selection monitoring by initiating communication between a mobile communication unit and a base station. The base station requests at least one vehicle preference setting from the mobile communication unit. Upon receiving the request for vehicle preference settings, the mobile communication unit determines vehicle preference data. The mobile communication unit transmits the vehicle preference data, to be received at the base station.

Another aspect of the invention presents a system for providing vehicle preference selection monitoring. The system includes a means for initiating communication between a mobile communication unit and a base station. In addition, the system provides the base station and mobile communication unit a means for requesting, receiving, compiling, and transmitting at least one vehicle preference setting.

Another aspect of the invention provides a computer readable medium for storing a computer program. The computer program is comprised of computer readable code capable of initiating communication between a mobile communication unit and a base station. Further, the computer readable code can be used to request at least one vehicle preference setting from the mobile communication unit, and for the mobile communication unit to receive the request. Additionally, the computer readable code is used by the mobile communication unit to determine any vehicle preference data requested. The computer readable code then is used to transmit to the base station the vehicle preference data from the mobile communication unit. Finally, computer readable code is used to receive the vehicle preference data at the base station.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram for one embodiment of a system for accessing a mobile vehicle using a wireless communication system, in accordance with the current invention;

FIG. 2 is a schematic diagram for one embodiment of a voice recognition system compatible with the system of FIG. 1, in accordance with the present invention;

FIG. 3 is a schematic view of one embodiment of an apparatus capable of utilizing the systems of FIG. 1 and FIG. 2, in accordance with the present invention; and

FIG. 4 is a flow chart representation for one embodiment of a vehicle preference selection monitoring method utilizing the systems of FIG. 1, FIG. 2, and FIG. 3, in accordance with the present invention.

### DETAILED DESCRIPTION OF THE PRESENTLY PREFERRED EMBODIMENTS

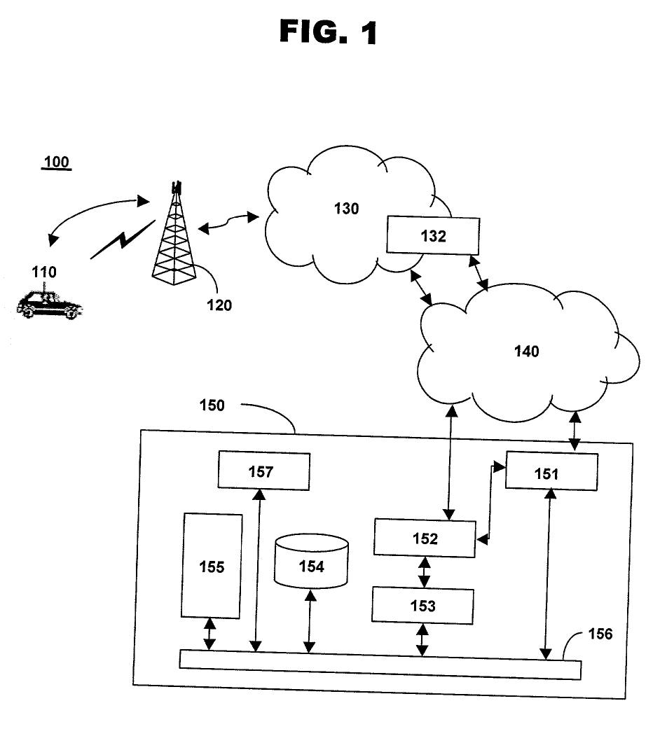

FIG. 1 shows an illustration of one embodiment of a system for communicating with a mobile vehicle using a wireless communication system in accordance with the present invention, and may be referred to as a mobile vehicle communication system (MVCS) 100, and in one embodiment may include the OnStar System as is known in the art. The mobile vehicle communication system 100 may contain one or more mobile vehicles (mobile vehicle communication unit) 110, one or more wireless carrier systems 120, one or more communication networks 130, one or more short message service centers 132, one or more land networks 140, and one or more call centers 150. Call center 150 may contain one or more switches 151, one or more data transmission devices 152, one or more communication services managers 153, one or more communication services databases 154, one or more advisors 155, one or more bus systems 156, and one or more automated speech recognition (ASR) units 157.

Mobile vehicle 110 may contain a wireless vehicle communication device (module, MVCS module) such as an analog or digital phone with suitable hardware and software for transmitting and receiving data communications. Mobile vehicle 110 may contain a wireless modem for transmitting and receiving data. Mobile vehicle 110 may contain a digital signal processor with software and additional hardware to enable communications with the mobile vehicle and to perform other routines and requested services. Mobile vehicle 110 may contain a global positioning system (GPS) unit capable of determining synchronized time and a geophysical location of the mobile vehicle. Mobile vehicle 110 may send to and receive radio transmissions from wireless carrier system 120. Mobile vehicle 110 may contain a speech recognition system (ASR) capable of communicating with the wireless vehicle communication device. The module may additionally be capable of functioning as any part or all of the above communication devices and, for one embodiment of the invention, may be capable of data storage, and/or data retrieval, and/or receiving, processing, and transmitting data queries.

Wireless carrier system 120 may be a wireless communications carrier or a mobile telephone system. The mobile telephone system may be an analog mobile telephone system operating over a prescribed band nominally at 800 MHz. The mobile telephone system may be a digital mobile telephone system operating over a prescribed band nominally at 800 MHz, 900 MHz, 1900 MHz, or any suitable band capable of carrying mobile communications. Wireless carrier system 120 may transmit to and receive signals from mobile vehicle 110. Wireless carrier system 120 may transmit to and receive signals from a second mobile vehicle 110. Wireless carrier system 120 may be connected with communications network 130.

Communications network 130 may comprise a mobile switching center. Communications network 130 may comprise services from one or more wireless communications companies. Communications network 130 may be any suitable system or collection of systems for connecting wireless carrier system 120 to at least one mobile vehicle 110 or to a call center.

Communications network 130 may include one or more short message service centers 132. Short message service center 132 may prescribe alphanumeric short messages to and from mobile vehicles 110. Short message service center 132 may include message entry features, administrative controls, and message transmission capabilities. For one embodiment of the invention, the short message service center 132 may include one or more automated speech recognition (ASR) units. Short message service center 132 may store and buffer the messages. Short message services may include functional services such as paging, text messaging and message waiting notification. Short message services may include other telematic services such as broadcast services, time-driven message delivery, autonomous message delivery, and database-driven information services. The telematic services may further include message management features, such as message priority levels, service categories, expiration dates, cancellations, and status checks.

Land network 140 may be a public-switched telephone network. Land network 140 may be comprised of a wired network, an optical network, a fiber network, another wireless network, or any combination thereof. Land network 140 may comprise an Internet protocol (IP) network. Land network 140 may connect communications network 130 to a call center. In one embodiment of the invention, a communication system may reference all or part of the wireless carrier system 120, communications network 130, land network 140, and short message service center 132.

Land network 140 may connect a first wireless carrier system 120 with a second wireless carrier system 120. Communication network 130 and land network 140 may connect wireless carrier system 120 to a communication node or call center 150.

Call center 150 may be a location where many calls can be received and serviced at the same time, or where many calls may be sent at the same time. The call center may be a telematic call center, prescribing communications to and from mobile vehicles 110. The call center may be a voice call center, providing verbal communications between an advisor in the call center and a subscriber in a mobile vehicle. The call center may be a voice activated call center, providing verbal communications between an ASR unit and a subscriber in a mobile vehicle. The call center may contain any of the previously described functions.

The call center may contain switch 151. Switch 151 may be connected to land network 140, and may receive a modem signal from an analog modem or from a digital modem. Switch 151 may transmit voice or data transmission from the communication node. Switch 151 may also receive voice or data transmissions from mobile vehicle 110 through wireless carrier system 120, communications network 130, and land network 140. Switch 151 may receive from or send data transmissions to data transmission device 152. Switch 151 may receive from or send voice transmissions to advisor 155 via bus system 156. Switch 151 may receive from or send voice transmissions to one or more automated speech recognition (ASR) units 157 via bus system 156.

Data transmission device 152 may send or receive data from switch 151. Data transmission device 152 may be an IP router or a modem. Data transmission device 152 may transfer data to or from advisor 155, one or more communication services managers 153, one or more communication services databases 154, one or more automated speech recognition (ASR) units 157, and any other device connected to bus system 156. Data transmission device 152 may convey information received from short message service center 132 in communication network 130 to communication services manager 153.

Communication services manager 153 may be connected to switch 151, data transmission device 152, and advisor 155 through bus system 156. The call center may contain any combination of hardware or software facilitating data transmissions between call center 150 and mobile vehicle 110.

Communication services manager 153 may receive information from mobile vehicle 110 through wireless carrier system 120, short message service center 132 in communication network 130, land network 140, and data transmission device 152. Communication services manager 153 may send information to mobile vehicle 110 through data transmission device 152, land network 140, communication network 130 and wireless carrier system 120. Communication services manager 153 may send short message service messages via short message service center 132 to the mobile vehicle. Communication services manager 153 may receive short message service replies from mobile vehicle 110 via short message service center 132. Communication services manager 153 may send a short message service request to mobile vehicle 110. Communication services manager 153 may receive from or send voice transmissions to one or more automated speech recognition (ASR) units 157.

In another embodiment of the invention, short message service (SMS) communications may be sent and received according to established protocols such as IS-637 standards for SMS, IS-136 air interface standards for SMS, and GSM 03.40 and 09.02 standards. These protocols allow for example, short messages comprised of up to 160 alpha-numeric characters and may contain no images or graphics. Similar to paging, an SMS communication may be posted along with an intended recipient, such as a communication device in mobile vehicle 110. The SMS communication may be sent by a communication services manager in a call center, transferred to a short message service center (SMSC), and conveyed to the intended recipient. In one embodiment of the invention, mobile vehicle 110 may receive an SMS message when the ignition is on, or when put into an SMS-ready or service-ready mode while the ignition is off. The mobile vehicle 110 may be placed in a powered down or quiescent mode while the ignition is off. When the mobile vehicle is placed into a service ready mode, the phone in the mobile vehicle may register with a local wireless carrier if needed, or with the subscriber's home system if the mobile vehicle is not roaming. If an SMS message is waiting to be sent, the wireless carrier may deliver the message and the mobile phone may acknowledge receipt of the message by an acknowledgment to the SMSC. Mobile vehicle 110 may perform an operation in response to the SMS message, and may send an SMS reply message back to the call center. Similarly, another embodiment of the mobile vehicle 110 may originate an SMS message to the call center through the SMSC.

In one embodiment of the invention, the communication services manager 153 may determine whether an SMS communication should be sent to mobile vehicle 110. An SMS message may be initiated in response to a subscriber request, such as a request to unlock the vehicle doors. An SMS message may be sent automatically, for example, when an update or vehicle preset value is desired or when a diagnostic message is needed. In another embodiment of the invention, a SMS message may be sent to periodically check the location and status of mobile vehicle 110, and for another embodiment of the invention, to request data collection, data retrieval, and/or data submission from mobile vehicle 110. Communication services manager 153 may also provide further requests and determinations based on a reply from mobile vehicle 110. Communication services manager 153 may provide information to mobile vehicle 110 from communication services database 154.

Communication services database 154 may contain records on one or more mobile vehicles 110. A portion of communication services database 154 may be dedicated to short message services. Records in communication services database 154 may include vehicle identification, location information, diagnostic information, status information, recent action information, and vehicle passenger (user) and operator (user) defined preset conditions regarding mobile vehicle 110. Communication services database 154 may provide information and other support to communication services manager 153 and automated speech recognition (ASR) units 157, and in one embodiment of the invention to external services. External services can be for example, vehicle repair services, rental agencies, marketing firms and manufacturers. Another embodiment of the invention may require external services to be authorized, such as having a multi-use license, or pre-approved such as for a one-time use.

Another embodiment of the invention may provide that communication services database 154 include geographic and/or mapping information that may include geographic features such as lakes, mountains, businesses, cities, malls, and any other feature that may be identifiable with a given location. The communication services database 154 may also include points of interest that can be spatially enabled, such as golf courses, rest areas, and historical markers.

Advisor 155 may be a real advisor or a virtual advisor. A real advisor may be a human being in verbal communication with mobile communication device 110. A virtual advisor may be a synthesized voice interface responding to requests from mobile communication device 110. Advisor 155 may provide services to mobile communication device 110. Advisor 155 may communicate with communication services manager 153, automated speech recognition (ASR) units 157, or any other device connected to bus system 156. Another embodiment of the invention may allow for the advisor 155 and ASR units 157 to be integrated as a single unit capable of any features described for either.

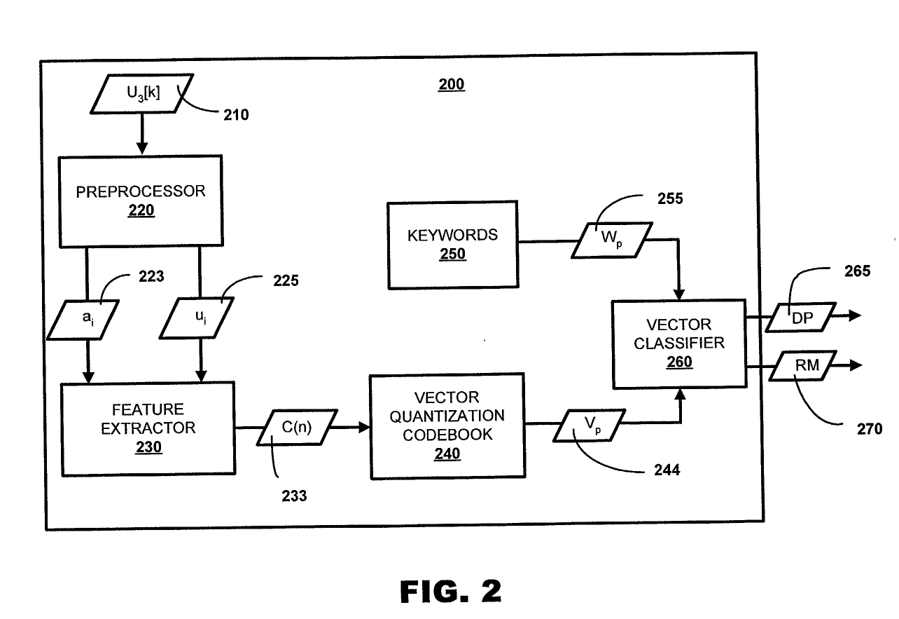

FIG. 2 illustrates one embodiment of an ASR unit 200 for ascertaining the acceptability of a spectral vector Vₚ. A preprocessor 220 may receive a speech signal U₃[k] 210 and in response, provide a set of pole-zero coefficients aᵢ 223 and uᵢ 225. The preprocessor 220 may use the assumption that the speech signal U₃[k] 210 is a linear combination of L previous samples. In one embodiment of the invention, the aᵢ 223 coefficients may be the resulting predictor coefficients, which may be chosen to minimize a mean square filter prediction error signal e[k] summed over an analysis window. Another embodiment of the invention may provide the preprocessor 220 to transform the speech signal U₃[k] 210 into a representation of a corresponding spectral signal U₃(Z).

A feature extractor 230 may receive pole-zero coefficients aᵢ 223 and uᵢ 225, and in response thereto, provide a set of cepstral coefficients C(n) 233 representative of a spectral parameters corresponding to speech signal U₃[k] 210.

A vector codebook 240 may receive cepstral coefficients C(n) 233 and conventionally provide spectral vector V_{p.} 244. In one embodiment of the invention, vector codebook 240 may conventionally transform the cepstral coefficients C(n) 233 to the spectral vector Vₚ 244.

A vector classifier 260 may receive the spectral vector Vₚ 244 as well as keyword Wₚ 255 from a keywords module 250. It may be assumed that the dimension of the spectral vector Vₚ 244 and keyword Wₚ 255 is m. Another embodiment of the invention may respond that the vector classifier 260 provide either the data packet DP 265 or the rejection message RM 270. Additionally, the keywords module 250 can be designed to produce voice recognition topics, which may be a group of words, pronunciations, and corresponding word usage statistics (language modeling), created for a specific subject, such as interstate travel, and vehicle user preferences (presets).

ASR unit 200 may consist of digital and/or analog hardware, software, or a combination of hardware and software. In alternative embodiments, ASR unit 200 may be incorporated within a wireless network, a wireline network, a filtering system, or distributed among a transceiver, a wireless network, a wireline network and/or a filtering system.

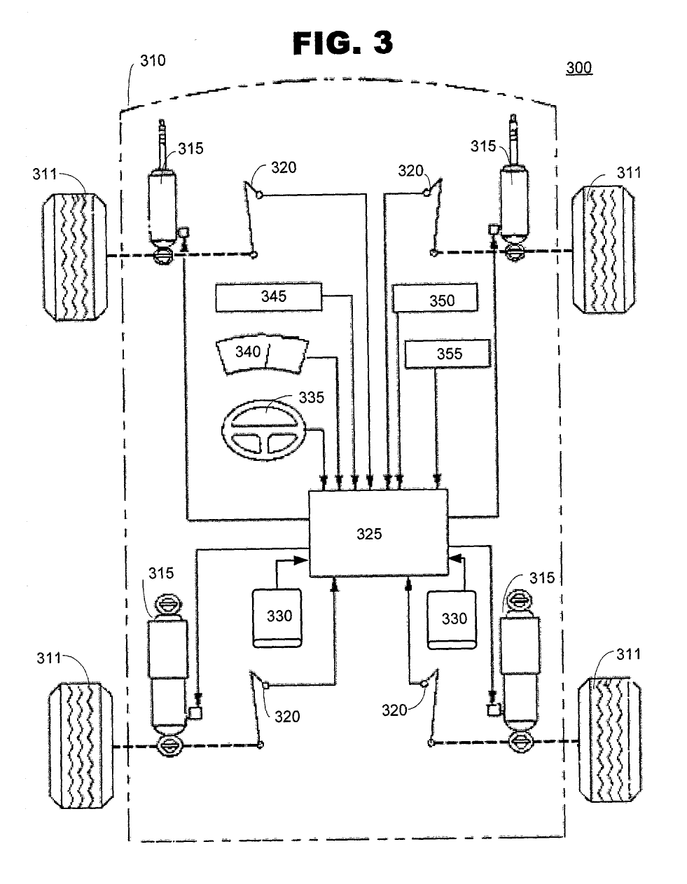

One embodiment of the invention is further illustrated in FIG. 3 as an example mobile vehicle (vehicle) 300, and may utilize one or more embodiments previously detailed. For one embodiment of the invention, the vehicle 300 may be comprised of a vehicle body 310 supported by four wheels 311 and by four suspension devices including springs (not shown), all of a type known in the art. Each suspension includes a variable-force real time controllable damper 315connected to exert a vertical force between wheel 311 and body 310 at that suspension point. There are many such suspension arrangements known in the art and all are appropriate to this invention.

Each corner of the vehicle may include a linear position sensor 320 that provides an output signal specifying the relative distance between the vehicle wheel and the suspended vehicle body at that corner of the vehicle. Suitable position sensors 320 can be easily constructed by those skilled in the art and any type of position sensor known in the art may be. Each position sensor 320 may provide a signal to a module 325.

In one embodiment of the invention, the outputs of the position sensors 320 may be provided to a controller (not shown) in communication with or part of the module 325, which can process the signals to determine the state of the vehicle body 310 and wheels 311 and generate an output actuator control signal for each variable actuator 315. The output actuator control signal may be applied from the controller through suitable output apparatus to control actuators 315 in real-time to provide a user defined suspension comfort level. Another embodiment of the invention may include sensors for use with user defined variable settings (presets). For example, at least one sensor may be included for any combination of seat position 330, vehicle speed 340, steering wheel angular position 335, radio settings 345, climate control (for variable atmospheric conditions) 350, and accessories such as mirror setting, dash lights, etc 355. An additional embodiment of the invention may include input signals from various vehicle diagnostic sensors, as are known in the art, as well as diagnostic sensors for systems affected by any user-defined presets, and any additional preset component known in the art and not previously mentioned. Obtaining such signals can be easily achieved using known types of sensors available to those skilled in the art, with the sensors in communication with the controller or the module 325.

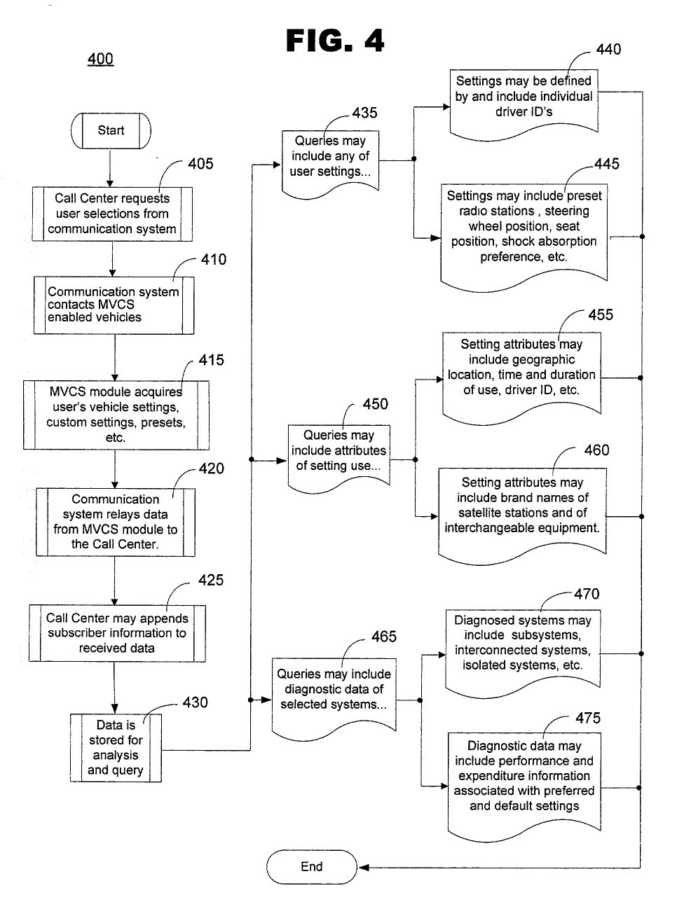

FIG. 4 is a flow chart representation for on embodiment of a vehicle preference selection monitoring method 400, utilizing one or more of the systems previously described in accordance with the present invention. The method may begin with the call center acting as a base station, periodically requesting vehicles for their user defined preferred (preset) configurations 405 and associated data, using a wireless communication system in accordance with the present invention. In one embodiment of the invention, the request may be solicited from the call center for a third party, for example, for a manufactures of vehicle components, for a department of transportation, or for any third party requiring information in accordance with the invention. In another embodiment of the invention, the request may be initiated by the user of the vehicle, verbally through ASR or through a call center advisor, or manually by a mechanical means such as a button. Another embodiment of the invention may provide the third party to act as the base station and request the preset configuration and associated data using a wireless communication system in accordance with the present invention.

Upon receiving a request from the call center, the communication system may contact vehicles capable of communicating in accordance with the present invention 410. The vehicles may be contacted as a group for batch processing of information (data), and individually if specific user data is requested. When the intended vehicles receive the call centers request, their module may acquire all or part of the vehicles user preset settings, vehicle settings (default values), custom settings, vehicle diagnostics, preset systems diagnostics, or any other information within the scope of the invention 415. Another embodiment of the invention may provide a memory within, or in contact with the module. The memory may be of any type known in the art suitable for providing at least one of the functions: storing, appending, manipulating, retrieving, and/or deleting of data. For one embodiment of the invention, appending may include any one or more of a time stamp, system identification, date stamp, and/or other informative attribute. The appending may be performed to the data as it is received from the sensors, during the course of any data storage, and during the transfer of the data.

When the vehicles requested data is transferred from the module, the communication system may relay the data to the call center 420. In another embodiment of the invention, the communication system may relay the data to a third party location. Additionally, one embodiment of the invention may provide that the call center relay the data to a third party. When the data is received at the call center, the call center may append additional information to the data, for example, subscriber information previously obtained from the vehicle user 425. The data may then be stored in a database at the call center and may be used for analysis, queries, or any other suitable purpose 430.

When the data is used for queries, one embodiment of the invention may provide data for any of the user-preset settings 435. The data for the settings may include driver identification 440. For one embodiment of the invention, the driver identification may be used for comport settings of individual drivers in multi-driver vehicles, for example, to reinstate a particular individuals preset settings. In another embodiment of the invention, a query of this data may be sent to a third party such as a car rental agency or new car dealership. Any vehicle capable of communicating in accordance with the invention may receive the data and install the user preset settings prior to their entering the vehicle. The settings may include but are not limited to any of radio stations, steering wheel position, seat position, shock absorption preference (comfort level), climate control, and light settings 445.

Another embodiment of the invention may provide queries to include attributes of the setting use 450. The setting attributes may include for example, information on geographic location during a settings use, time and duration of the settings use, and the driver identification 455. Additionally, setting attributes may include brand names of satellite radio stations, and of interchangeable vehicle equipment manufactured for use within the scope of the invention 460.

Further, another embodiment of the invention may provide queries to include diagnostic data of one or more individual system 465. The system may be comprised of any one or more components, and may include subsystems, interconnected systems, and isolated systems within the target vehicle 470. The diagnostic data may include system performance and expenditure information associated with preset and default settings 475.

The above-described methods and implementation for vehicle preference selection (presets) monitoring and associated information are example methods and implementations. These methods and implementations illustrate one possible approach for ascertaining a vehicles preset data and associated information. The actual implementation may vary from the method discussed. Moreover, various other improvements and modifications to this invention may occur to those skilled in the art, and those improvements and modifications will fall within the scope of this invention as set forth below.

The present invention may be embodied in other specific forms without departing from its spirit or essential characteristics. The described embodiments are to be considered in all respects only as illustrative and not restrictive.

We claim:

1. A method for vehicle preference selection monitoring comprising:
initiating communication between a mobile communication unit and a base station, wherein communication is performed within a mobile vehicle communication system;
requesting at least one vehicle preference setting from the mobile communication unit;
receiving the vehicle preference setting request at the mobile communication unit;
determining vehicle preference setting for the mobile communication unit;
transmitting to the base station the vehicle preference setting from the mobile communication unit; and
receiving the vehicle preference data at the base station.

2. The method of claim 1 wherein the vehicle preference setting includes a satellite radio receiver preference setting.

3. The method of claim 1 wherein the base station is a call center.

4. The method of claim 1 wherein the base station is a third party.

5. The method of claim 1 wherein the vehicle preference setting is requested by the mobile communication unit.

6. The method of claim 1 wherein the vehicle preference setting is determined by a module.

7. The method of claim 1 wherein the vehicle preference setting is determined from a memory.

8. The method of claim 1 further comprising appending at least one vehicle attribute to the vehicle preference setting.

9. The method of claim 1 further comprising appending at least one system diagnostic to the vehicle preference setting.

10. The method of claim 1 further comprising appending at least one vehicle default setting to the vehicle preference setting.

11. The method of claim 1 further comprising appending at least one user identifier to the vehicle preference setting.

12. The method of claim 1 further comprising appending subscriber information to the vehicle preference setting.

13. The method of claim 1 further comprising storing the received vehicle preference setting in a database.

14. A system for vehicle preference selection monitoring comprising:
means for initiating communication between a mobile communication unit and a base station, wherein communication is performed within a mobile vehicle communication system;
means for requesting at least one vehicle preference setting from the mobile communication unit;
means for receiving the vehicle preference setting request at the mobile communication unit;
means for determining vehicle preference setting for the mobile communication unit;
means for transmitting to the base station the vehicle preference setting from the mobile communication unit; and
means for receiving the vehicle preference data at the base station.

15. The system of claim 14 further comprising means for appending at least one vehicle attribute to the vehicle preference setting.

16. The system of claim 14 further comprising means for appending at least one system diagnostic to the vehicle preference setting.

17. The system of claim 14 further comprising means for appending at least one vehicle default setting to the vehicle preference setting.

18. The system of claim 14 further comprising means for appending at least one user identifier to the vehicle preference setting.

19. The system of claim 14 further comprising means for appending subscriber information to the vehicle preference setting.

20. The system of claim 14 further comprising means for storing the received vehicle preference setting in a database.

21. A computer readable medium storing a computer program comprising:
computer readable code for initiating communication between a mobile communication unit and a base station, wherein communication is performed within a mobile vehicle communication system;
computer readable code for requesting at least one vehicle preference setting from the mobile communication unit;
computer readable code for receiving the vehicle preference setting request at the mobile communication unit;
computer readable code for determining vehicle preference setting for the mobile communication unit;
computer readable code for transmitting to the base station the vehicle preference setting from the mobile communication unit; and
computer readable code for receiving the vehicle preference data at the base station.

22. The computer readable medium of claim 21 further comprising computer readable code for appending at least one vehicle attribute to the vehicle preference setting.

23. The computer readable medium of claim 21 further comprising computer readable code for appending at least one system diagnostic to the vehicle preference setting.

24. The computer readable medium of claim 21 further comprising computer readable code for appending at least one vehicle default setting to the vehicle preference setting.

25. The computer readable medium of claim 21 further comprising computer readable code for appending at least one user identifier to the vehicle preference setting.

26. The computer readable medium of claim 21 further comprising computer readable code for appending subscriber information to the vehicle preference setting.

27. The computer readable medium of claim 21 further comprising computer readable code for storing the received vehicle preference setting in a database.
